(19) United States
(12) Patent Application Publication
(10) Pub. No.: US 2025/0381842 A1
(43) Pub. Date: Dec. 18, 2025

(54) VEHICLE

(71) Applicant: KAWASAKI MOTORS, LTD., Hyogo (JP)

(72) Inventor: Yusuke NAKASHIMA, Akashi-shi (JP)

(73) Assignee: KAWASAKI MOTORS, LTD., Hyogo (JP)

(21) Appl. No.: 18/740,543

(22) Filed: Jun. 12, 2024

(51) Int. Cl. B60K 26/02; B62D 25/20

(52) U.S. Cl. CPC B60K 26/02; B62D 25/20

(57) ABSTRACT

A utility vehicle 100 includes: a floor board 1; a body frame 2 supporting the floor board 1; and an accelerator pedal assembly 3 including an accelerator pedal 31 located above the floor board 1 and an arm 32 extending from the accelerator pedal 31 to a position below the floor board 1. The body frame 2 includes an attachment frame 23 to which the accelerator pedal assembly 3 is attached. The attachment frame 23 is located immediately below the floor board 1.

### FIELD

The technique disclosed here relates to a vehicle.

### BACKGROUND

U.S. Patent Application Publication No. 2007/0138863 discloses a utility vehicle including a floor structure, a frame structure supporting the floor structure, and an accelerator and brake assembly. The floor structure includes an opening penetrating the floor structure in the top-bottom direction. The accelerator and brake assembly is inserted in the opening from above and attached to the frame structure below the opening. A cover for closing the opening is located at the opening.

### SUMMARY

In the vehicle described above, additional components such as the cover for closing the opening might be needed to avoid interference between driver's feet and the accelerator and brake assembly or other reasons. This can lead to an increase in the number of parts.

It is therefore an object of the technique disclosed here to reduce the number of parts.

The vehicle disclosed here includes: a floor board; a body frame supporting the floor board; and a pedal assembly including a pedal located above the floor board and an arm extending from the pedal to a position below the floor board, wherein the body frame includes an attachment frame to which the pedal assembly is attached, and the attachment frame is located immediately under the floor board.

In the vehicle, the number of parts can be reduced.

### BRIEF DESCRIPTION OF THE DRAWINGS

FIG. 1 is a side view of a utility vehicle.

FIG. 2 is a perspective view of a front portion of a cabin when obliquely seen from the left rear.

FIG. 3 is a perspective view of the front portion of the cabin from which a floor board and a front board are removed when obliquely seen from the left rear.

FIG. 4 is a left side view of an accelerator pedal assembly attached to a body frame.

FIG. 5 is a perspective view of the accelerator pedal assembly when obliquely seen from the left rear.

FIG. 6 is an illustration for describing an operation action of an arm.

FIG. 7 is a perspective view of the accelerator pedal assembly attached to the body frame when obliquely seen from the right front.

FIG. 8 is a bottom view of the body frame and the accelerator pedal assembly.

FIG. 9 is a perspective view of the front portion of the cabin around the accelerator pedal assembly when obliquely seen from the left rear.

FIG. 10 is a perspective view of the accelerator pedal assembly attached to the body frame when obliquely seen from the right front, and is a perspective view for describing an attachment state of the accelerator pedal assembly to an attachment frame.

### DESCRIPTION OF EMBODIMENTS

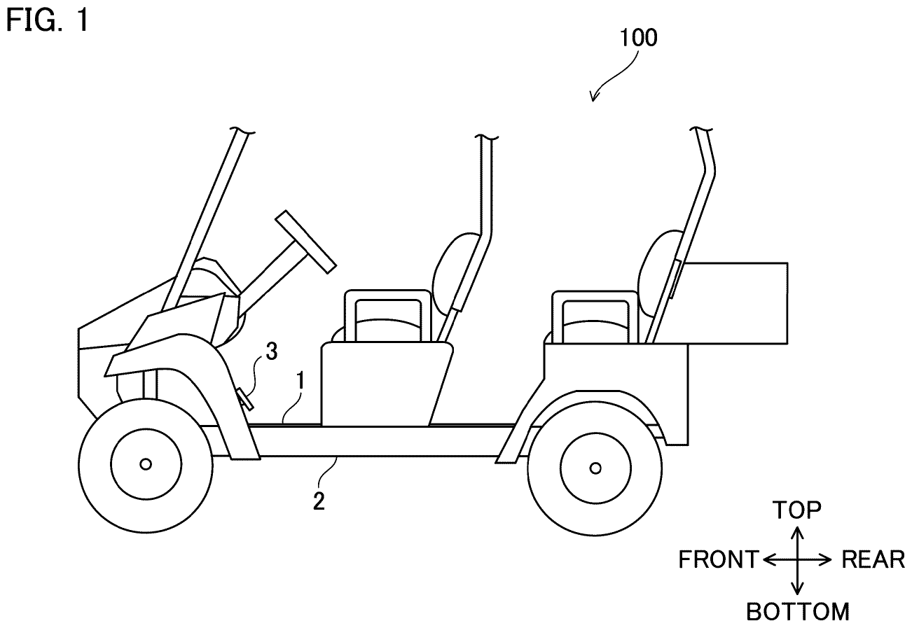

An exemplary embodiment will be described in detail hereinafter with reference to the drawings. FIG. 1 is a side view of a utility vehicle 100. The utility vehicle 100 will be hereinafter also simply referred to as a “vehicle 100.”

The vehicle 100 corresponds to one example of a vehicle disclosed here. The vehicle 100 is a vehicle intended to travel at low speed in a limited area. Examples of the limited area include a limited community area, a private road, and a private property (e.g., a golf course, a park, etc.). The limited community area refers to an area available for use by local residents. The community area is, for example, an area including houses and public facilities (e.g., schools, hospitals, etc.), and is an area where the vehicle 100 not intended to travel on a public road is permitted to travel at low speed. The low speed refers to a speed up 20 mph to 30 mph, for example. The vehicle 100 includes, for example, a personal transport vehicle (PTV). The PTV includes a golf cart.

In this disclosure, components of the vehicle 100 will be described based on directions of the vehicle 100. Specifically, “front” refers to the front of the vehicle 100 in the vehicle front-rear direction, and “rear” refers to the rear of the vehicle 100 in the vehicle front-rear direction. “Left” refers to the left of the vehicle 100 when seeing forward, and “right” refers to the right of the vehicle 100 when seeing forward. The “vehicle width direction” refers to the vehicle width direction of the vehicle 100, in other words, means the left-right direction of the vehicle 100 and will be sometimes referred to as a “left-right direction.” An “inner side in the vehicle width direction” refers to a cabin side in the vehicle width direction, and an “outer side in the vehicle width direction” refers to a vehicle outer side in the vehicle width direction. The expression “a member extends or expands in a direction” herein includes not only a case where the member extends or expands strictly in parallel with the direction” but also a case where the member extends or expands generally in the direction.

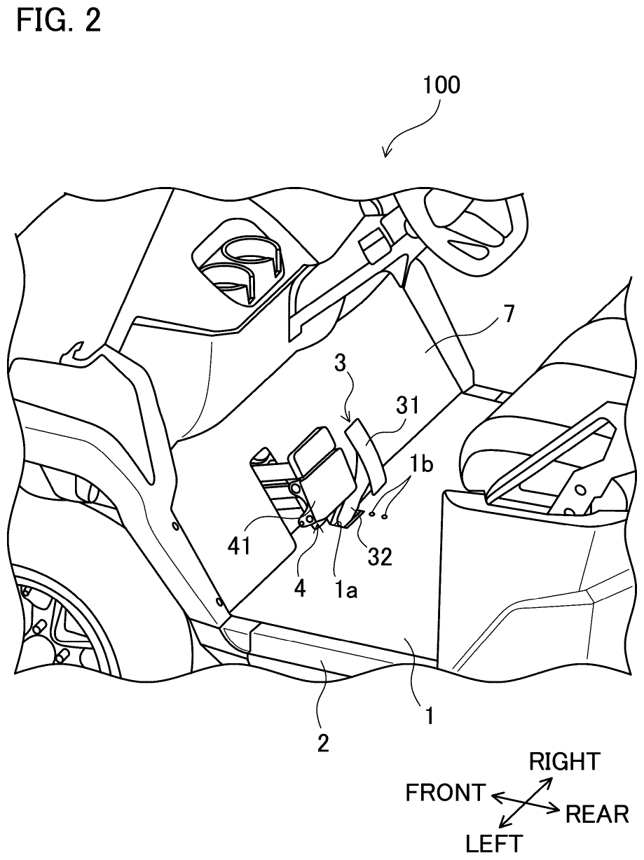

FIG. 2 is a perspective view of a front portion of a cabin when obliquely seen from the left rear. The vehicle 100 includes a floor board 1, a body frame 2 supporting the floor board 1, and an accelerator pedal assembly 3. The accelerator pedal assembly 3 transfers the amount of depression of an accelerator pedal by a driver to an engine. The vehicle 100 may further include a brake pedal assembly 4 and a front board 7 defining the front end of the cabin. The brake pedal assembly 4 transfers the amount of depression of a brake pedal by the driver to a brake system. The brake pedal assembly 4 includes a brake pedal 41. The brake pedal 41 is a part with which a foot of the driver is brought into contact during braking of the vehicle 100. The accelerator pedal assembly 3 is an example of a pedal assembly. The brake pedal 4 is an example of “another pedal.”

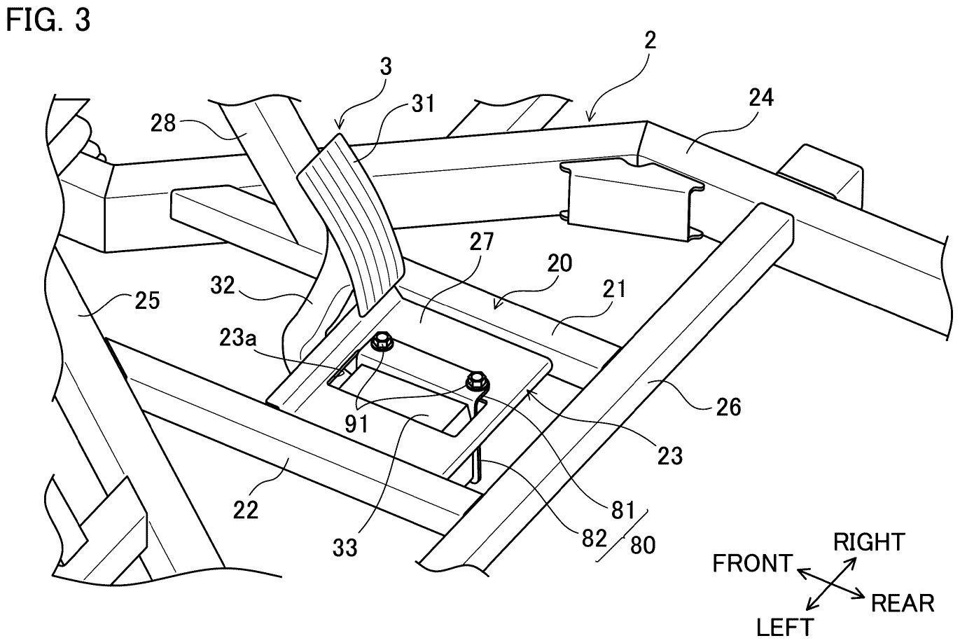

FIG. 3 is a perspective view of the front portion of the cabin from which the floor board 1 and the front board 7 are removed when obliquely seen from the left rear. The body frame 2 is a frame structure serving as a framework of a lower portion of the body of the vehicle 100. The body frame 2 is constituted by combining metal pipe parts, metal plate parts, or casted parts, for example.

The body frame 2 includes an attachment frame 23 located immediately under the floor board 1 (see FIG. 2). The expression “a first member is located below a second member” herein refers only to a positional relationship between the first member and the second member in the top-bottom direction, and does not concern positional relationships in directions other than the top-bottom direction, such as a positional relationship in the front-rear direction and a positional relationship in the vehicle width direction. The expression “the first member is located immediately under the second member” refers to a case where the first member is located below the second member and the first member is located on an inner side of the outer periphery of the second member when seen in the top-bottom direction.

The body frame 2 further includes a support frame 20 which is located immediately under the floor board 1 and on which the floor board 1 is placed. The support frame 20 includes a first support frame 21 and a second support frame 22. The body frame 2 may further include a first side frame 24 adjacent to the first support frame 21 on an outer side in the vehicle width direction, a second side frame 25 adjacent to the second support frame 22 on an outer side in the vehicle width direction, a cross frame 26 coupling the first side frame 24 and the second side frame 25, and a tilt frame 28 extending forward and upward from an upper surface of the first support frame 21. In this example, the first support frame 21, the second support frame 22, the first side frame 24, the second side frame 25, the cross frame 26, and the tilt frame 28 are square pipes.

The first side frame 24 extends in the front-rear direction as a whole. A front portion of the first side frame 24 bends inward in the vehicle width direction. The second side frame 25 extends in the front-rear direction as a whole. A front portion of the second side frame 25 bends inward in the vehicle width direction. The cross frame 26 extends in the vehicle width direction.

The first support frame 21 extends in the front-rear direction. A front end of the first support frame 21 is coupled to the front portion of the first side frame 24 by, for example, welding. A rear end of the first support frame 21 is coupled to the cross frame 26 by, for example, welding. The second support frame 22 extends in the front-rear direction. A front end of the second support frame 22 is coupled to the front portion of the second side frame 25 by, for example, welding. A rear end of the second support frame 22 is coupled to the cross frame 26 by, for example, welding. The first support frame 21 and the second support frame 22 are disposed side by side in the vehicle width direction.

The accelerator pedal assembly 3, specifically, an arm 32 described later, is attached to the attachment frame 23. The attachment frame 23 has a plate shape expanding in the front-rear direction and the vehicle width direction as a whole. The attachment frame 23 is coupled to the support frame 20. In this example, the attachment frame 23 is located between the first support frame 21 and the second support frame 22. The attachment frame 23 is coupled to both the first support frame 21 and the second support frame 22. Specifically, one end of the attachment frame 23 in the vehicle width direction is coupled to the first support frame 21 by, for example, welding, and the other end of the attachment frame 23 in the vehicle width direction is coupled to the second support frame 22 by, for example, welding.

The attachment frame 23 includes a placement surface 27 facing upward. The placement surface 27 is at least a portion of an upper surface of the attachment frame 23. A portion of the accelerator pedal assembly 3 is placed on the placement surface 27. The placement surface 27 is located immediately under the floor board 1 (see FIG. 2). In this example, the placement surface 27 is a flat surface expanding in the front-rear direction and the vehicle width direction.

In this example, the attachment frame 23 includes a frame through hole 23a penetrating the attachment frame 23 in the top-bottom direction. The frame through hole 23a is an example of a “through hole which is located in the placement surface and through which a hanger passes.” The frame through hole 23a has an approximately rectangular shape whose long-side direction is substantially parallel to the front-rear direction and whose short-side direction is substantially parallel to the vehicle width direction. The frame through hole 23a is located substantially at the center of the attachment frame 23 in the vehicle width direction. The frame through hole 23a is located in the placement surface 27.

As illustrated in FIG. 2, the floor board 1 serves as a floor of the cabin. A floor mat may be further placed on the floor board 1. The floor board 1 has a plate shape expanding in the front-rear direction and the vehicle width direction. Specifically, in the front-rear direction, the floor board 1 extends from a front end of a lower portion of the cabin to at least a position at which a front sheet is located. In the vehicle width direction, the floor board 1 extends from one outer end of the cabin in the vehicle width direction to the other outer end of the cabin in the vehicle width direction. In this example, the floor board 1 is integrated. That is, the floor board 1 is not divided and is continuous. The floor board 1 is made of, for example, a metal.

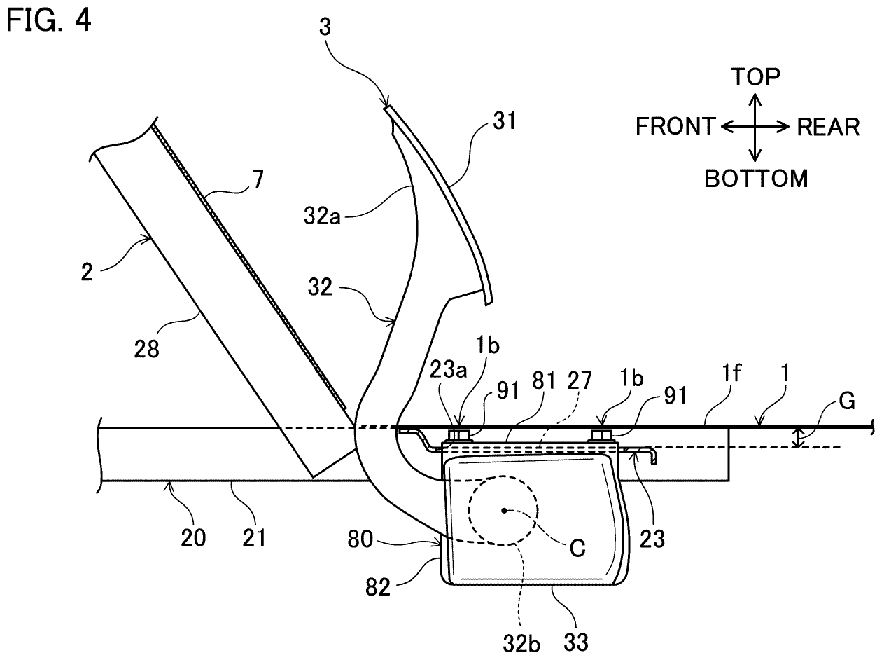

FIG. 4 is a left side view of the accelerator pedal assembly 3 attached to the body frame 2. In FIG. 4, for convenience of description, the floor board 1, the front board 7, and the attachment frame 23 are cut in a plane orthogonal to the vehicle width direction. In FIG. 4, for convenience of description, hatching of a cross section of the floor board 1 is omitted.

The floor board 1 is placed on the body frame 2. Specifically, the floor board 1 is placed on the first support frame 21, the second support frame 22, the first side frame 24, the second side frame 25, and the cross frame 26 (see FIG. 3 for the second support frame 22, the first side frame 24, the second side frame 25, and the cross frame 26). In this example, the floor board 1 is in contact with each of the first support frame 21, the second support frame 22, the first side frame 24, the second side frame 25, and the cross frame 26. The floor board 1 is attached to the body frame 2 by, for example, rivets.

The front board 7 prevents objects and other substances that may fly from the front from entering the cabin. The front board 7 is located forward of an accelerator pedal 31 described later. The front board 7 is detachably attached to the tilt frame 28.

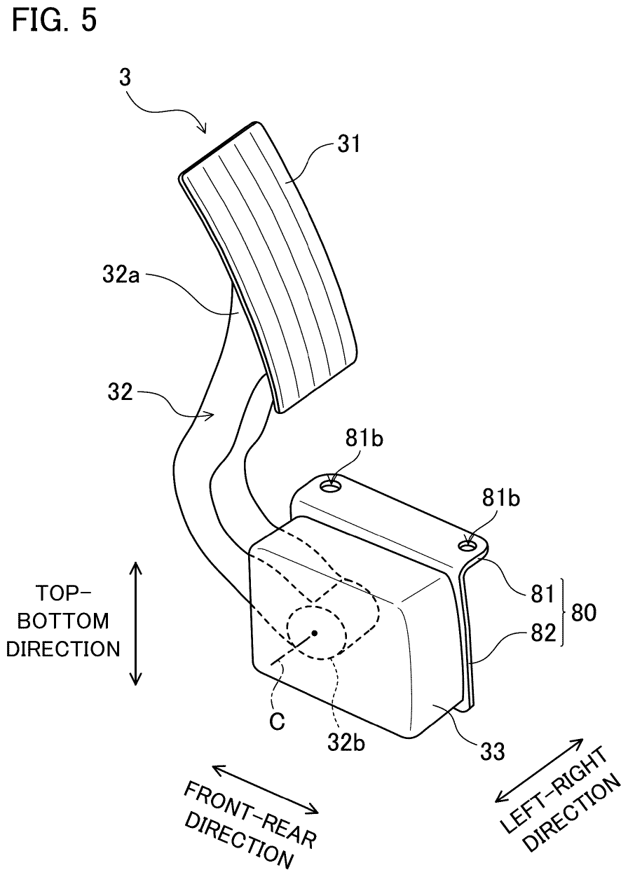

FIG. 5 is a perspective view of the accelerator pedal assembly 3 when obliquely seen from the left rear. The accelerator pedal assembly 3 includes the accelerator pedal 31 and the arm 32. The accelerator pedal 31 is an example of a pedal. The accelerator pedal assembly 3 may further include a housing 33 housing a portion of the arm 32 and a hanger 80 coupled to the arm 32, specifically coupled to the arm 32 through the housing 33.

The accelerator pedal 31 is a part that contacts a foot of the driver. The accelerator pedal 31 has an approximately rectangular shape having a longitudinal direction and a lateral direction. The accelerator pedal 31 is oriented such that the lateral direction thereof is substantially parallel to the vehicle width direction. The accelerator pedal 31 is located above the floor board 1 (see FIG. 4).

The arm 32 transfers a depression force of the driver onto the accelerator pedal 31, to the inside of the housing 33. The arm 32 extends from the accelerator pedal 31 to a position below the floor board 1. The arm 32 bends to project forward.

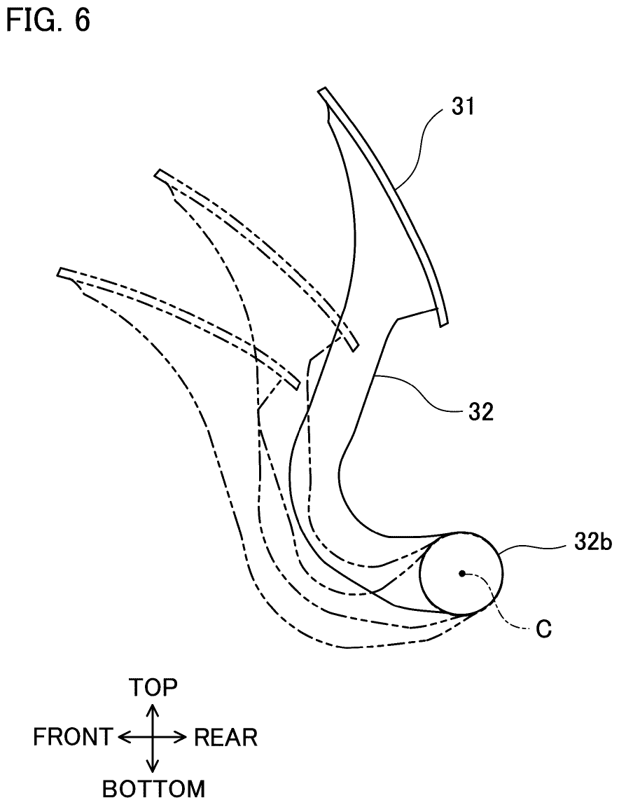

Specifically, a first end portion 32a of the arm 32 in a direction in which the arm 32 extends is attached to the accelerator pedal 31. A second end portion 32b of the arm 32 in the direction in which the arm 32 extends is supported by the housing 33 such that the arm 32 is rotatable about a rotation axis C. That is, as illustrated in FIG. 6, when the driver depresses the accelerator pedal 31, the arm 32 rotates about the rotation axis C. FIG. 6 is an illustration for describing a rotation action of the arm 32. The rotation axis C extends in the vehicle width direction. In this example, the rotation axis C is located in the second end portion 32b of the arm 32. As illustrated in FIG. 4, the rotation axis C is located below the attachment frame 23. In terms of a position in the front-rear direction, the rotation axis C is located between at least two fastening positions of a hanging portion 81 described later to the attachment frame 23.

The housing 33 houses at least the second end portion 32b of the arm 32. The housing 33 has a box shape having an accommodation space therein. The housing 33 is located below the attachment frame 23. In this example, the housing 33 also houses a rotation angle sensor that detects a rotation angle of the arm 32. When the rotation angle sensor detects a rotation angle of the arm 32, the detected rotation angle is transferred to a control unit. The control unit transfers this rotation angle to, for example, an engine.

As illustrated in FIG. 3, the hanger 80 hangs the arm 32 on the attachment frame 23. In this example, the hanger 80 hangs the accelerator pedal 31, the arm 32, and the housing 33 on the attachment frame 23.

As illustrated in FIG. 5, the hanger 80 includes the hanging portion 81 located above the rotation axis C of the arm 32. The hanging portion 81 is placed on the placement surface 27 of the attachment frame 23 (see FIG. 3). The hanging portion 81 has a plate shape expanding in the front-rear direction and the vehicle width direction. The hanging portion 81 has a longitudinal direction substantially parallel to the front-rear direction. That is, the hanging portion 81 is elongated in the front-rear direction. The longitudinal direction is a direction with the largest dimension among a dimension in the front-rear direction, a dimension in the vehicle width direction, and a dimension in the top-bottom direction. The hanging portion 81 has two through holes 81b in which bolts 91 described later are inserted. The hanger 80 further includes an attachment portion 82. The attachment portion 82 is attached to the housing 33. The attachment portion 82 has a plate shape expanding in the front-rear direction and the top-bottom direction. An upper end of the attachment portion 82 is coupled to an end of the hanging portion 81 in the vehicle width direction. That is, in this example, the hanger 80 has an L-shaped bracket. The hanger 80 is made of, for example, a metal.

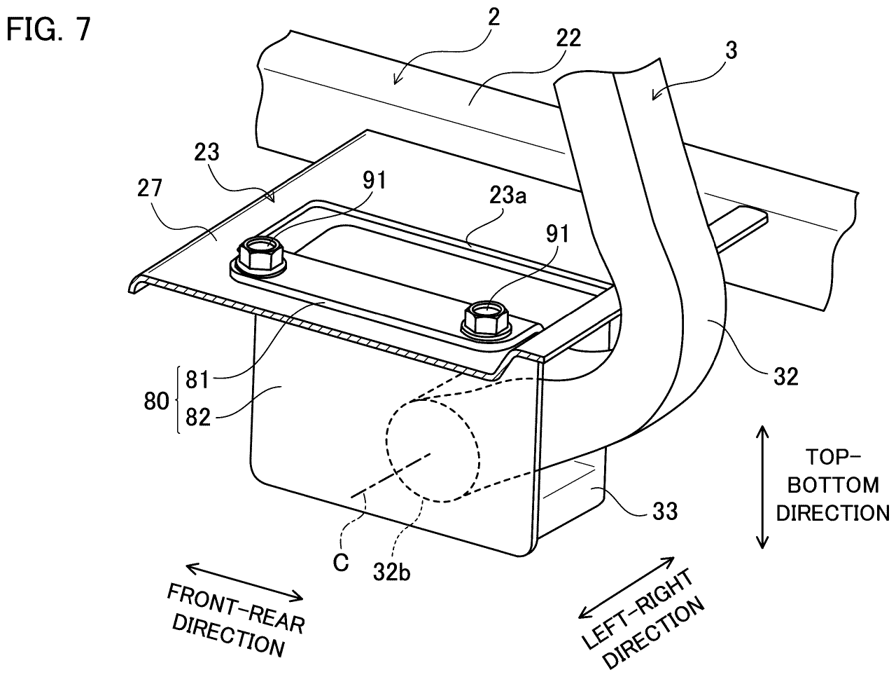

Next, an attachment structure of the accelerator pedal assembly 3 to the attachment frame 23 will be described in detail. FIG. 7 is a perspective view of the accelerator pedal assembly 3 attached to the body frame 2 when obliquely seen from the right front. For convenience of description, FIG. 7 does not show the floor board 1.

The accelerator pedal assembly 3 is placed on the placement surface 27 of the attachment frame 23. Specifically, the accelerator pedal assembly 3 is placed on the placement surface 27 of the attachment frame 23 from above. More specifically, the accelerator pedal assembly 3 is placed on the placement surface 27 through the hanger 80.

Specifically, as illustrated in FIG. 4, a gap G in the top-bottom direction is defined between the placement surface 27 of the attachment frame 23 and the floor board 1. Specifically, the placement surface 27 is located below a portion of an upper surface of the support frame 20 on which the floor board 1 is placed. Accordingly, in the state where the floor board 1 is placed on the support frame 20, the gap G in the top-bottom direction is defined between the placement surface 27 and the floor board 1.

As described above, the second end portion 32b of the arm 32 is supported by the housing 33 such that the arm 32 is rotatable about the rotation axis C. The attachment portion 82 of the hanger 80 is attached to the housing 33. The attachment portion 82 extends upward from the housing 33 and passes through the frame through hole 23a. The hanging portion 81 of the hanger 80 is coupled to the upper end of the attachment portion 82. The hanging portion 81 is inserted in the gap G and placed on the placement surface 27. In this manner, the arm 32 is placed on the placement surface 27 through the hanger 80.

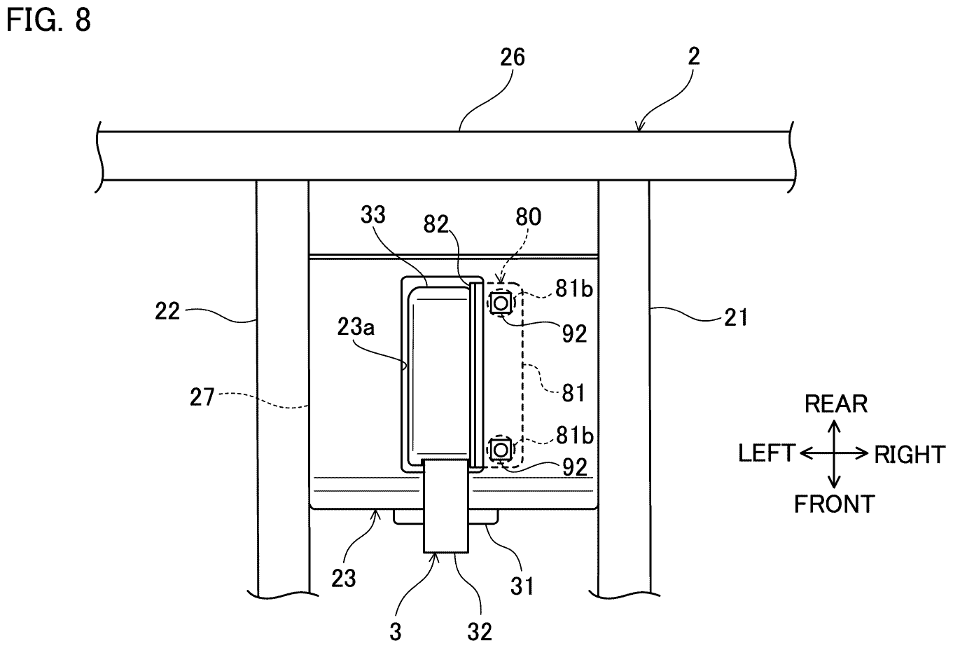

In this example, the accelerator pedal assembly 3 is fastened to the placement surface 27 from above with the bolts 91. Specifically, the hanger 80 is fastened to the placement surface 27 from above with the bolts 91. Specifically, as illustrated in FIG. 8, at least a portion of the hanging portion 81 of the hanger 80 is placed on the placement surface 27 to overlap the placement surface 27 in the top-bottom direction. FIG. 8 is a bottom view of the body frame 2 and the accelerator pedal assembly 3. The hanging portion 81 is fastened to the attachment frame 23 at at least two fastening positions disposed in the front-rear direction. In this example, a portion of the hanging portion 81 overlapping the placement surface 27 in the top-bottom direction is fastened to the attachment frame 23 by two bolts 91 (see FIG. 7). More specifically, two welding nuts 92 are attached to a lower surface of the attachment frame 23 at the fastening portions to the hanging portion 81. The bolts 91 are inserted in the through holes 81b of the hanging portion 81, and the bolts 91 are screwed to the welding nuts 92, thereby fastening the hanging portion 81 to the attachment frame 23.

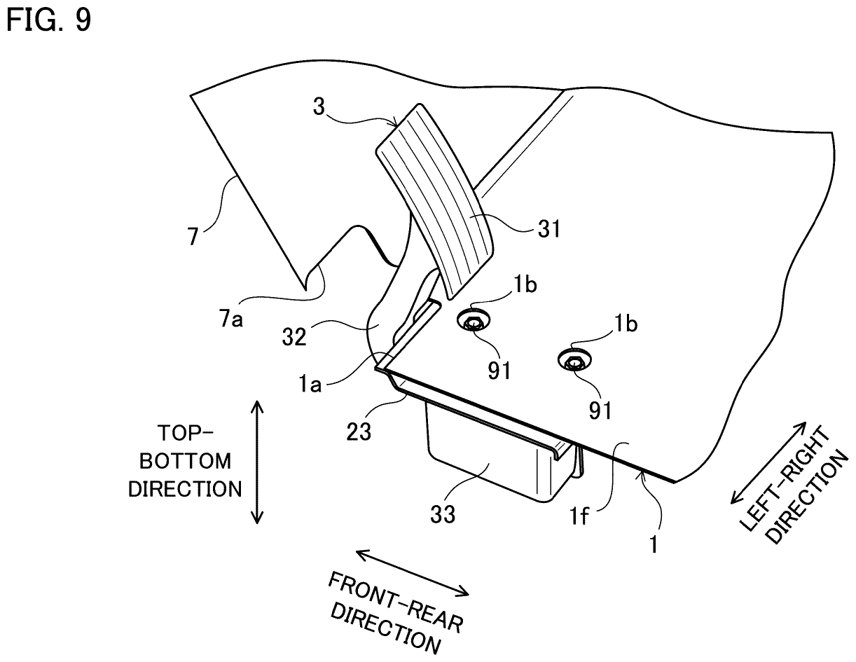

FIG. 9 is a perspective view of the front portion of the cabin around the accelerator pedal assembly 3 when obliquely seen from the left rear. In FIG. 9, for convenience of description, the attachment frame 23, the floor board 1, and the front board 7 are cut in a plane orthogonal to the vehicle width direction.

The floor board 1 includes board through holes 1b penetrating the floor board 1 in the top-bottom direction. In this example, the floor board 1 includes two board through holes 1b corresponding to the two bolts 91. The heads of the bolts 91 are located inside the board through holes 1b when seen in the top-bottom direction. The heads of the bolts 91 are located below an upper surface 1f of the floor board 1 (see also FIG. 4). That is, the heads of the bolts 91 do not project upward from the floor board 1. As illustrated in FIG. 2, the board through holes 1b is located opposite to the brake pedal 41 with respect to the accelerator pedal 31 in the vehicle width direction.

As illustrated in FIG. 9, in this example, a front edge of the floor board 1 has a notch 1a. The notch 1a is recessed rearward. The arm 32 is located in the notch 1a. That is, the arm 32 extends downward from above the floor board 1 through the notch 1a.

A lower edge of the front board 7 includes a notch 7a for avoiding interference with the arm 32 when the arm 32 rotates about the rotation axis C.

Then, an example of an attachment method and a detachment method of the accelerator pedal assembly 3 to/from the body frame 2 to which the floor board 1 is attached. To attach the accelerator pedal assembly 3 to the body frame 2, the housing 33 of the accelerator pedal assembly 3 is first placed below the attachment frame 23. Before this step, the front board 7 may be detached from the body frame 2. Thereafter, the accelerator pedal assembly 3 is moved upward, and the hanging portion 81 of the hanger 80 is passed through the frame through hole 23a. Subsequently, the hanging portion 81 is placed on the placement surface 27 of the attachment frame 23. At this time, the arm 32 is placed in the notch 1a of the floor board 1. Then, the bolts 91 are inserted in the board through holes 1b and the through holes 81b of the hanging portion 81 from above the floor board 1, and the bolts 91 are screwed to the welding nuts 92. In this manner, the accelerator pedal assembly 3 is attached to the attachment frame 23. To detach the accelerator pedal assembly 3 from the body frame 2, it is sufficient to perform the procedure opposite to the aforementioned method for attaching the accelerator pedal assembly 3 to the body frame 2.

In such a vehicle 100, the accelerator pedal assembly 3 is attached to the attachment frame 23 located immediately under the floor board 1. Accordingly, a relatively large member such as the housing 33 can also be placed immediately under the floor board 1. Consequently, the floor board 1 does not need to have an opening for placing a member such as the housing 33, and no additional parts such as a cover for closing the opening are needed. As a result, the number of parts can be reduced. In addition, since a relatively large member such as the housing 33 can be placed immediately under the floor board 1, the housing 33 and other members are less likely to project upward from the floor board 1, and floor space around the feet of the driver can be obtained. Further, since no additional parts such as a cover for closing the opening are needed, it is unnecessary to attach additional parts such as a cover to the body frame 2. Thus, the attachment step in attaching the floor board 1 and other members to the body frame 2 can be simplified.

Moreover, since the accelerator pedal assembly 3 is placed on the placement surface 27 of the attachment frame 23, even if the bolts 91 are loosened, the accelerator pedal assembly 3 is less likely to drop from the attachment frame 23. In this example, the accelerator pedal assembly 3 is fastened to the placement surface 27 from above with the bolts 91. Accordingly, attachment work or detachment work of the bolts 91 can be performed from above, and thus, the accelerator pedal assembly 3 can be easily attached and detached to/from the attachment frame 23.

In this example, the rotation axis C of the arm 32 is located below the attachment frame 23. The hanger 80 includes the hanging portion 81 located above the rotation axis C of the arm 32 and placed on the placement surface 27. The arm 32 is placed on the placement surface 27 through the hanger 80. Accordingly, the structure of attaching the accelerator pedal assembly 3 to the attachment frame 23 can be achieved. In particular, in this example, the hanger 80 is fastened to the placement surface 27 from above with the bolts 91. Accordingly, attachment work or detachment work of the bolts 91 can be performed from above, and thus, the accelerator pedal assembly 3 can be easily attached or detached to/from the attachment frame 23.

The heads of the bolts 91 are located inside the board through holes 1b when seen in the top-bottom direction. Accordingly, a user can perform attachment work or detachment work of the bolts 91 through the board through holes 1b from above the floor board 1. That is, with the floor board 1 attached to the body frame 2, the accelerator pedal assembly 3 can be attached or detached to/from the body frame 2. In addition, the heads of the bolts 91 are located below the upper surface 1f of the floor board 1. Accordingly, the bolts 91 do not project upward from the floor board 1, and thus, the bolts 91 are less likely to serve as obstacles around the feet of the driver.

The gap G in the top-bottom direction is defined between the placement surface 27 and the floor board 1. Accordingly, the hanging portion 81 of the hanger 80 can be inserted in the gap G, and thus, the structure of attaching the accelerator pedal assembly 3 to the attachment frame 23 can be easily achieved.

The front edge of the floor board 1 has the notch 1a, and the arm 32 is located in the notch 1a. Accordingly, the accelerator pedal assembly 3 can be easily attached to the attachment frame 23. Even if the front edge of the floor board 1 has no notch 1a, the accelerator pedal assembly 3 needs to be located further forward of the attachment frame 23 as compared to the case where the front edge of the floor board 1 has the notch 1a. Thus, there is the possibility of difficulty in attaching the accelerator pedal assembly 3 to the attachment frame 23.

### OTHER EMBODIMENTS

In the foregoing section, the embodiment has been described as an example of the technique disclosed in the present application. The technique disclosed here, however, is not limited to this embodiment, and is applicable to other embodiments obtained by changes, replacements, additions, and/or omissions as necessary. Components described in the above embodiment may be combined as a new embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

The vehicle 100 may be a single-passenger vehicle. The vehicle 100 may be a vehicle with a single row of seats or a vehicle with three rows of seats. The vehicle 100 may be a tricycle including three wheels, or may be a six-wheeled vehicle including six wheels.

The shape, arrangement, and other characteristics of the floor board 1 are not limited. For example, the floor board 1 may not include the notch 1a. For example, the floor board 1 may not include the board through holes 1b. A member such as a cushioning material different from the floor board 1 may be placed between the floor board 1 and the body frame 2.

The shapes, numbers, arrangement, and other features of parts such as metal pipe parts, metal plate parts, or casted parts included in the body frame 2 are not limited. The shape of the frame through hole 23a is not limited. The attachment frame 23 may not include the frame through hole 23a. In this case, the arm 32 of the accelerator pedal assembly 3 may be attached to the lower surface of the attachment frame 23.

The brake pedal assembly 4 may be a pedal assembly of the present disclosure. That is, the arm of the brake pedal assembly 4 may be attached to the attachment frame located immediately under the floor board 1.

The arm 32 may be directly attached to the first support frame 21 or the second support frame 22 through the hanger 80. That is, the first support frame 21 or the second support frame 22 may be an attachment frame.

The arm 32 may not be attached to the attachment frame 23 through the hanger 80. For example, the arm 32 may be attached to the attachment frame 23 by directly attaching the housing 33 to the attachment frame 23. For example, the accelerator pedal assembly 3 may not include the hanger 80, and the attachment frame 23 may include a recess that is recessed downward. The housing 33 may be placed in this recess and attached to the attachment frame 23.

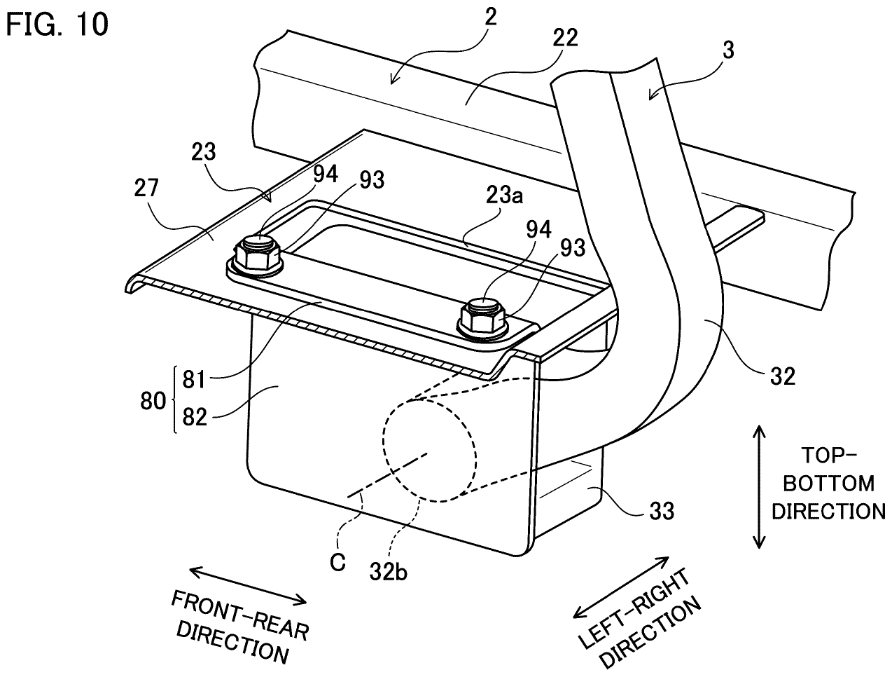

As illustrated in FIG. 10, the accelerator pedal assembly 3 may be fastened to the placement surface 27 from above with nuts 93. FIG. 10 is a perspective view of the accelerator pedal assembly 3 attached to the body frame 2 when obliquely seen from the right front, and is a perspective view for describing an attachment state of the accelerator pedal assembly 3 to the attachment frame 23. For example, stud bolts 94 extending in the top-bottom direction may be attached to the placement surface 27 so that the nuts 93 are screwed to the stud bolts 94 from above to thereby fasten the accelerator pedal assembly 3 to the attachment frame 23. The hanger 80 may be fastened to the lower surface of the attachment frame 23 with the bolts 91. Specifically, the hanging portion 81 may be fastened to the attachment frame 23 with the bolts 91 in a state where an upper surface of the hanging portion 81 of the hanger 80 is in contact with the lower surface of the attachment frame 23.

The gap G in the top-bottom direction may not be defined between the placement surface 27 and the floor board 1. That is, the placement surface 27 and the floor board 1 may be in contact with each other. In this state, the hanger 80 is preferably attached to the lower surface of the attachment frame 23.

The vehicle of the present disclosure may be an off-road vehicle or an on-road vehicle. The off-road vehicle may be an all terrain vehicle (ATV) or a tractor.

### [Aspects]

The embodiment described above are a specific example of the following aspects.

(Aspect 1) A vehicle (utility vehicle 100) includes: a floor board 1; a body frame 2 supporting the floor board 1; and the pedal assembly (accelerator pedal assembly 3) including the pedal (accelerator pedal 31) located above the floor board 1 and the arm 32 extending from the accelerator pedal 31 to a position below the floor board 1, the body frame 2 includes the attachment frame 23 to which the pedal assembly (accelerator pedal assembly 3) is attached, and the attachment frame 23 is located immediately under the floor board 1.

In the configuration, the pedal assembly is attached to the attachment frame 23 located immediately under the floor board 1. Accordingly, even in a case where the pedal assembly includes a relatively large member such as a housing, the housing or other members can be located immediately under the floor board 1. As a result, the floor board 1 does not need to have an opening for placing a member such as the housing, and no additional parts such as a cover for closing the opening are needed. As a result, the number of parts can be reduced.

(Aspect 2) In the vehicle 100 of aspects 1, the attachment frame 23 includes the placement surface 27 facing upward, and the pedal assembly (accelerator pedal assembly 3) is placed on the placement surface 27.

With this configuration, even in a case where the bolts or other members for attaching the pedal assembly to the attachment frame 23 are loosened, the pedal assembly is less likely to drop from the attachment frame 23.

(Aspect 3) In the vehicle 100 of aspects 1 or 2, the pedal assembly (accelerator pedal assembly 3) is fastened to the placement surface 27 from above with the bolt 91 or the nut 93.

With this configuration, since attachment work or detachment work of the bolt 91 or the nut 93 can be performed from above, the pedal assembly can be easily attached or detached to/from the attachment frame 23.

(Aspect 4) In the vehicle 100 of any one of aspects 1 to 3, the accelerator pedal assembly 3 further includes the hanger 80 that is coupled to the arm 32 and hangs the arm 32 on the attachment frame 23, the rotation axis C of the arm 32 is located below the attachment frame 23, the hanger 80 includes hanging portion 81 located above the rotation axis C of the arm 32 and placed on the placement surface 27, and the pedal assembly (accelerator pedal assembly 3) is placed on the placement surface 27 through the hanger 80.

This configuration achieves a structure of attaching the pedal assembly to the attachment frame 23 located immediately under the floor board 1.

(Aspect 5) In the vehicle 100 of any one of aspects 1 to 4, the hanger 80 is fastened to the placement surface 27 from above with the bolt 91 or the nut 93.

With this configuration, since attachment work or detachment work of the bolt 91 can be performed from above, the pedal assembly can be easily attached or detached to/from the attachment frame 23.

(Aspect 6) In the vehicle 100 of any one of aspects 1 to 5, the attachment frame 23 includes the through hole 23a which is located in the placement surface 27 and through which the hanger 80 passes.

With this configuration, the arm 32 can be hung from the attachment frame 23.

(Aspect 7) In the vehicle 100 of any one of aspects 1 to 6, the hanging portion 81 includes the longitudinal direction substantially parallel to the front-rear direction.

With this configuration, a load of the accelerator pedal assembly 3 applied to the placement surface 27 can be distributed in the front-rear direction.

(Aspect 8) In the vehicle 100 of any one of aspects 1 to 7, the hanging portion 81 is fastened to the attachment frame 23 at at least two fastening positions disposed in the front-rear direction, and in terms of a position in the front-rear direction, the rotation axis C of the arm 32 is located between the at least two fastening positions.

With this configuration, support stiffness of the accelerator pedal assembly 3 can be enhanced.

(Aspect 9) In the vehicle 100 of any one of aspects 1 to 8, the floor board 1 includes the board through hole 1b penetrating the floor board 1 in the top-bottom direction, and the head of the bolt 91 or the nut 93 is located in the board through hole 1b when seen in the top-bottom direction.

With this configuration, a user can perform attachment work or detachment work of the bolt 91 or the nut 93 through the board through hole 1b from above the floor board 1. That is, with the floor board 1 attached to the body frame 2, the pedal assembly can be attached or detached to/from the body frame 2.

(Aspect 10) In the vehicle 100 of any one of aspects 1 to 9, the head of the bolt 91 or the nut 93 is located below the upper surface 1f of the floor board 1.

With this configuration, the bolt 91 or the nut 93 does not project upward from the floor board 1, and thus, the bolt 91 or the nut 93 is less likely to serve as an obstacle around the feet of a driver.

(Aspect 11) The vehicle 100 of any one of aspects 1 to 10 further includes another (brake pedal 41) adjacent to the pedal (accelerator pedal 31) in the vehicle width direction, and the board through holes 1b is located on the opposite side to the another pedal (brake pedal 41) with respect to the pedal (accelerator pedal 31) in the vehicle width direction.

With this configuration, it is possible to attach or detach the pedal assembly (accelerator pedal assembly 3) to/from the attachment frame 23, while avoiding interference with the another pedal (brake pedal 41).

(Aspect 12) In the vehicle 100 of any one of aspects 1 to 11, the body frame 2 further includes the support frame 20 which is located immediately under the floor board 1 and on which the floor board 1 is placed, the attachment frame 23 is coupled to the support frame 20, and the gap G in the top-bottom direction is defined between the placement surface 27 and the floor board 1.

With this configuration, the pedal assembly can be attached to the attachment frame 23 by utilizing the gap G. For example, an L-shaped bracket is inserted in the gap G and placed on the placement surface 27 so that the pedal assembly can be thereby attached to the attachment frame 23 through the bracket.

(Aspect 13) In the vehicle 100 of any one of aspects 1 to 12, the body frame 2 further includes the support frame 20 which is located immediately under the floor board 1 and on which the floor board 1 is placed, the support frame 20 includes the first support frame 21 and the second support frame 22 separated from the first support frame 21 in the vehicle width direction, and the attachment frame 23 is located between the first support frame 21 and the second support frame 22 and coupled to both the first support frame 21 and the second support frame 22.

This configuration can enhance support stiffness of the attachment frame 23.

(Aspect 14) In the vehicle 100 of any one of aspects 1 to 13, the front edge of the floor board 1 includes the notch 1a, and the arm 32 is located in the notch 1a.

This configuration enables the pedal assembly to be easily attached to the attachment frame 23. Even if the front edge of the floor board 1 has no notch 1a, the pedal assembly needs to be located further forward of the attachment frame 23 as compared to the case where the front edge of the floor board 1 has the notch 1a. Thus, there is the possibility of difficulty in attaching the pedal assembly to the attachment frame 23.

(Aspect 15) In the vehicle 100 of any one of aspects 1 to 14, the pedal is the accelerator pedal 31.

This configuration can achieve a structure of attaching the accelerator pedal assembly 3 to the attachment frame 23.

1. A vehicle comprising:
a floor board;
a body frame supporting the floor board; and
a pedal assembly including a pedal located above the floor board and an arm extending from the pedal to a position below the floor board, wherein
the body frame includes an attachment frame to which the pedal assembly is attached, and
the attachment frame is located immediately under the floor board.

2. The vehicle according to claim 1, wherein
the attachment frame includes a placement surface facing upward, and
the pedal assembly is placed on the placement surface.

3. The vehicle according to claim 2, wherein
the pedal assembly is fastened to the placement surface from above with a bolt or a nut.

4. The vehicle according to claim 2, wherein
the pedal assembly further includes a hanger that is coupled to the arm and hangs the arm on the attachment frame,
a rotation axis of the arm is located below the attachment frame,
the hanger includes a hanging portion located above a rotation axis of the arm and placed on the placement surface, and
the pedal assembly is placed on the placement surface through the hanger.

5. The vehicle according to claim 4, wherein
the hanger is fastened to the placement surface from above with a bolt or a nut.

6. The vehicle according to claim 4, wherein
the attachment frame includes a through hole which is located in the placement surface and through which the hanger passes.

7. The vehicle according to claim 4, wherein
the hanging portion includes a longitudinal direction substantially parallel to a front-rear direction.

8. The vehicle according to claim 4, wherein
the hanging portion is fastened to the attachment frame at at least two fastening positions disposed in a front-rear direction, and
in terms of a position in the front-rear direction, the rotation axis of the arm is located between the at least two fastening positions.

9. The vehicle according to claim 3, wherein
the floor board includes a board through hole penetrating the floor board in a top-bottom direction, and
a head of the bolt or the nut is located in the board through hole when seen in the top-bottom direction.

10. The vehicle according to claim 9, wherein
the head of the bolt or the nut is located below an upper surface of the floor board.

11. The vehicle according to claim 9, further comprising
another pedal adjacent to the pedal in a vehicle width direction, and
the board through hole is located on an opposite side to the another pedal with respect to the pedal in the vehicle width direction.

12. The vehicle according to claim 2, wherein
the body frame further includes a support frame which is located immediately under the floor board and on which the floor board is placed,
the attachment frame is coupled to the support frame, and
a gap in a top-bottom direction is defined between the placement surface and the floor board.

13. The vehicle according to claim 2, wherein
the body frame further includes a support frame which is located immediately under the floor board and on which the floor board is placed,
the support frame includes a first support frame and a second support frame separated from the first support frame in a vehicle width direction, and
the attachment frame is located between the first support frame and the second support frame and coupled to both the first support frame and the second support frame.

14. The vehicle according to claim 1, wherein
a front edge of the floor board includes a notch, and
the arm is located in the notch.

15. The vehicle according to claim 1, wherein
the pedal is an accelerator pedal.
